(19) United States
(12) Patent Application Publication
(10) Pub. No.: US 2022/0267194 A1
(43) Pub. Date: Aug. 25, 2022

(54) ETCHING DEVICE AND ETCHING METHOD USING THE SAME

(71) Applicant: Samsung Display Co., LTD., Yongin-si (KR)

(72) Inventors: Jae Hoon JEONG, Bucheon-si (KR); Jin Seock KIM, Seongnam-si (KR); Seung Yo YANG, Suwon-si (KR); Byung-Seo YOON, Hwaseong-si (KR); Jung Kyu JO, Hwaseong-si (KR); Kyu Young KIM, Suwon-si (KR); Han Sun RYOU, Seoul (KR); Jin Nyoung HEO, Yongin-si (KR)

(73) Assignee: Samsung Display Co., LTD., Yongin-si (KR)

(21) Appl. No.: 17/522,461

(22) Filed: Nov. 9, 2021

(30) Foreign Application Priority Data
Feb. 23, 2021 (KR) 10-2021-0023997

(51) Int. Cl. C03C 15/00

(52) U.S. Cl. CPC C03C 15/00

(57) ABSTRACT

An etching device includes a chamber; a supporter disposed in the chamber; a heater disposed in the supporter; and an applier disposed on the supporter. A glass is disposed on the supporter, the applier applies an etchant on the glass such that a thickness of the etchant applied reduces from a center of the glass toward an edge of the glass.

### CROSS-REFERENCE TO RELATED APPLICATION(S)

This application claims priority to and the benefit of Korean Patent Application No. 10-2021-0023997 under 35 U.S.C. § 119, filed in the Korean Intellectual Property Office (KIPO) on Feb. 23, 2021, the entire contents of which are incorporated herein by reference.

### BACKGROUND

### 1. Technical Field

The disclosure relates to an etching device and an etching method using the same.

### 2. Description of the Related Art

Recently, various mobile electronic devices including a portable phone, a GPS, a digital camera, an e-book, a portable game device, and various types of terminals to which display devices such as a liquid crystal display (LCD) or an organic light emitting display (OLED) are applied are in use.

A cover window configured to be transparent so that a user may watch a display unit from a front of a display panel may be provided to a conventional display device used in the above-noted mobile electronic devices. The cover window is configured to the outermost portion of the display device, so it must be strong against external impacts to protect the display panel in the display device.

Recently, display devices with numerous variations such as bending or folding are widely spread, so the cover window of the display device also requires the bending or folding physical properties.

The above information disclosed in this Background section is only for enhancement of understanding of the background of the disclosure, and therefore it may contain information that does not form the prior art that is already known in this country to a person of ordinary skill in the art.

### SUMMARY

The disclosure has been made in an effort to provide an etching device having increased thickness differences between a folding unit and an unfolding unit of a glass by etching the folding unit at an increased etching speed, and an etching method using the same.

An embodiment of the disclosure provides an etching device including a chamber; a supporter disposed in the chamber; a heater disposed in the supporter; and an applier disposed on the supporter. A glass may be disposed on the supporter, the applier may apply an etchant on the glass such that a thickness of the etchant applied reduces from a center of the glass toward an edge of the glass.

The heater may overlap a thickest portion of the etchant applied on the glass.

The heater may directly contact the glass.

The etching device may further include a chemically resistant layer disposed between the heater and the glass, wherein the heater does not directly contact the glass.

The heater may be a sheath heater, an infrared heater, or a lamp.

The applier may have a syringe or slit form.

The applier may spray an etchant or a cleaning solution according to a process.

A groove may be formed on a portion of the glass etched by the etching device where the heater is disposed, and a surface of the groove may have a freely curved surface.

Another embodiment of the disclosure provides an etching method including positioning a glass on a supporter including a heater; and applying an etchant on the glass such that a thickness of the etchant applied reduces from a center of the glass toward an edge of the glass and etching the glass with the etchant to form an etched glass. The heater may overlap a thickest portion of the etchant applied on the glass.

A region of the etched glass overlapping the heater may be etched more than a region of the etched glass not overlapping the heater, and the etched glass may be etched less as the etched glass becomes distant from the heater.

A groove may be formed in a portion of the etched glass overlapping the heater, and a surface of the groove may have a freely curved surface.

A thickness of a thinnest portion of a region of the etched glass having the groove may be in a range of about 25 μm to about 30 μm, and a thickness of a region of the etched glass not having the groove may be in a range of about 50 μm to about 70 μm.

A thickness of the region of the etched glass having the groove may be in a range of about 1.5 to about 2.5 times the thickness of the region of the etched glass having the groove.

The etching method may further include, after the etching of the glass with the etchant to form the etched glass, applying a cleaning solution on the etched glass, and cleaning the etched glass to remove an etching sludge.

The etching method may further include, after the cleaning of the etched glass to remove the etching sludge, applying another etchant on the cleaned etched glass to etch the cleaned etched glass for a second time.

The cleaning of the etched glass and the applying of the another etchant may be performed in a same chamber.

The cleaning solution may be distilled water or a cleaning etchant.

A thickness of the etchant applied to the glass may be in a range of about 2 mm to about 4 mm.

A mask may not be used for the etching of the glass.

The heater may directly contact the glass, or the heater may include a chemically resistant layer disposed between the heater and the glass, and may not directly contact the glass.

According to the embodiments, the etching device for increasing the thickness difference between the folding unit and the unfolding unit by increasing the etching speed of the folding unit of the glass, and the etching method using the same.

### BRIEF DESCRIPTION OF THE DRAWINGS

An additional appreciation according to the embodiments of the disclosure will become more apparent by describing in detail the embodiments thereof with reference to the accompanying drawings, wherein:

FIG. 1 is a cross-sectional view schematically illustrating a glass etching device according to the embodiment.

FIGS. 2 and 3 are perspective views schematically illustrating various shapes of an applier.

FIG. 4 schematically illustrates an etchant applied on a glass according to the embodiment.

FIG. 5 schematically illustrates a configuration in which a glass is disposed vertically according to another embodiment.

FIG. 6 schematically illustrates heat efficiency for respective regions according to an embodiment (Embodiment 1) described with reference to FIG. 4 and an embodiment (Embodiment 2) described with reference to FIG. 5.

FIG. 7 schematically illustrates a shape of an etched glass in a cross-sectional view according to an embodiment described with reference to FIG. 5 in a same condition, and FIG. 8 schematically illustrates a shape of an etched glass in a cross-sectional view according to an embodiment described with reference to FIG. 4 in a same condition.

FIG. 9 schematically illustrates a glass etched by positioning a mask in a cross-sectional view.

FIG. 10 schematically illustrates an inner stress of a glass according to an embodiment described with reference to FIG. 9.

FIG. 11 schematically illustrates an etched glass according to the embodiment.

FIG. 12 schematically illustrates an inner stress of a glass according to an embodiment described with reference to FIG. 11.

FIG. 13 schematically illustrates an inner stress with respect to position according to an embodiment (Embodiment 3) described with reference to FIG. 9 and FIG. 10 and an embodiment (Embodiment 4) described with reference to FIG. 11 and FIG. 12.

FIGS. 14 and 15 schematically illustrate shapes of a heater according to various embodiments.

FIGS. 16 and 17 schematically illustrate a sheath heater.

FIG. 18 schematically illustrates an infrared heater.

FIG. 19 schematically illustrates an etched glass according to the embodiment.

FIG. 20 schematically illustrates thicknesses for respective glass regions with respect to etching time in an etching method according to the embodiment.

FIG. 21 schematically illustrates a process of an etching method according to the embodiment.

FIG. 22 schematically illustrates a stage (S10) for etching for a first time.

FIG. 23 schematically illustrates a stage (S20) for cleaning a surface.

FIG. 24 schematically illustrates a stage (S30) for etching for a second time.

FIG. 25 schematically illustrates a stage (S40) for cleaning and drying.

FIG. 26 schematically illustrates a glass including a folding region and an unfolding region.

FIG. 27 schematically illustrates a temperature with respect to time in an experiment.

FIGS. 28 to 30 schematically illustrate measured temperature gradients for respective regions with respect to a line A-A′ of FIG. 26 after applying an etchant with a thickness of 3.5 mm.

FIG. 31 schematically illustrates measured temperature gradients for respective regions with respect to a line A-A′ of FIG. 26 after applying an etchant with a thickness of 10 mm.

FIG. 32 schematically illustrates a glass that is not etched according to the embodiment.

FIG. 33 schematically illustrates an etched glass according to the embodiment.

### DETAILED DESCRIPTION OF THE EMBODIMENTS

The disclosure will be described more fully hereinafter with reference to the accompanying drawings, in which embodiments of the disclosure are shown. As those skilled in the art would realize, the described embodiments may be modified in various different ways, all without departing from the spirit or scope of the disclosure.

Parts that are irrelevant to the description will be omitted to clearly describe the disclosure, and the same elements will be designated by the same reference numerals throughout the specification.

The size and thickness of each configuration shown in the drawings are arbitrarily shown for better understanding and ease of description, but the disclosure is not limited thereto. In the drawings, the thickness of layers, films, panels, regions, etc., may be exaggerated for clarity.

It will be understood that when an element such as a layer, film, region, or substrate is referred to as being “on” another element, it can be directly on the other element or intervening elements may also be present. In contrast, when an element is referred to as being “directly on” another element, there are no intervening elements present. The word “on” or “above” means disposed on or below the object portion, and does not necessarily mean disposed on the upper side of the object portion based on a gravitational direction.

Unless explicitly described to the contrary, the word “comprise” and variations such as “comprises” or “comprising” will be understood to imply the inclusion of stated elements but not the exclusion of any other elements.

The phrase “in a plan view” means viewing an object portion from the top, and the phrase “in a cross-sectional view” means viewing a cross-section of which the object portion is vertically cut from the side.

The terms “about” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

A glass etching device and a glass etching method according to an embodiment of the disclosure will now be described with reference to accompanying drawings.

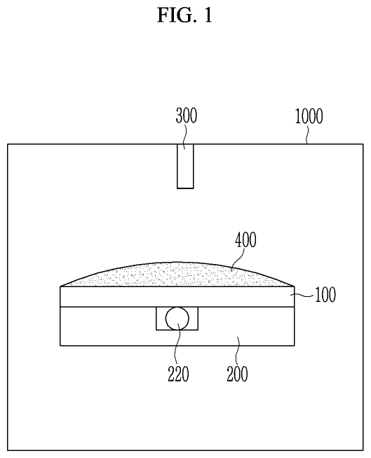

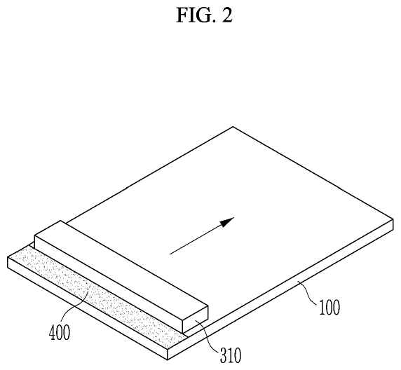

FIG. 1 is a cross-sectional view illustrating a glass etching device according to the embodiment. Referring to FIG. 1, a supporter 200 and an applier 300 are disposed in a chamber 1000, and a glass 100 is disposed on the supporter 200. The applier 300 applies an etchant 400 on the glass 100, and FIG. 1 illustrates the applied etchant 400.

Referring to FIG. 1, the etching device includes a heater 220 disposed in a groove of the supporter 200. The heater 220 may be disposed to directly contact the glass 100 as shown in FIG. 1, or the heater 220 may be provided into the supporter 200 so that it may not directly contact the glass 100.

A region of the overlapping the heater 220 is much more etched than another region. Therefore, in case that the glass 100 is applied to the foldable display device, it is thin so that the glass 100 may be well bent.

As shown in FIG. 1, the etchant 400 is disposed to be curved on an upper side of the glass 100. For example, the thickness of the applied etchant 400 is variable depending on the position of the glass 100. This is a freely curved surface that is naturally drawn by the surface tension of the glass 100 without an additional process.

As shown in FIG. 1, the etchant 400 has a thick portion in its center, and it becomes thinner toward the edge, so the etched thickness of the glass 100 may become different for respective regions. For example, the etchant 400 is applied to be the thickest in the center of the glass 100, and the lowest portion is the most etched as the heater 220 is disposed thereon. Therefore, the thickness of the corresponding portion becomes thin, and the glass 100 may be readily folded.

Referring to FIG. 1, the applier 300 is illustrated as a syringe form, which is however an example and it may have a slit form depending on embodiments.

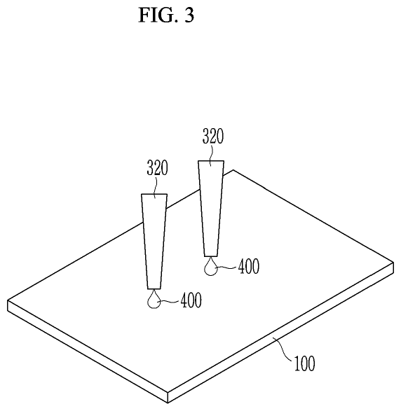

FIGS. 2 and 3 are perspective views illustrating various shapes of an applier 300. Referring to FIG. 2, the applier 300 may have a slit form 310, and it may proceed on the glass 100 in a direction and may apply the etchant 400.

Referring to FIG. 3, the applier 300 may have a syringe form 320, and it may drop the etchant 400 on the upper side of the glass 100 from the syringe 320 to apply the same thereon. FIGS. 2 and 3 may be examples, and the shape of the applier 300 is not limited thereto.

As shown in FIG. 1, the etching device horizontally positions the glass 100, and the etchant 400 is applied on the glass 100. The etchant 400 is fixed on the glass 100 by the surface tension.

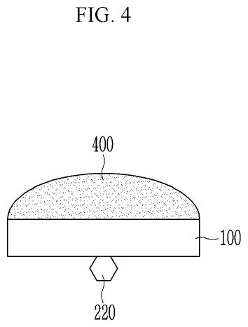

FIG. 4 illustrates an etchant 400 applied on a glass 100 according to the embodiment. As shown in FIG. 4, a heater 220 is disposed in a center bottom of the glass 100, and an etchant 400 is disposed on an upper side of the glass 100 by the surface tension to form a freely curved surface. Therefore, heat from the heater 220 is uniformly transmitted and heat efficiency may be improved.

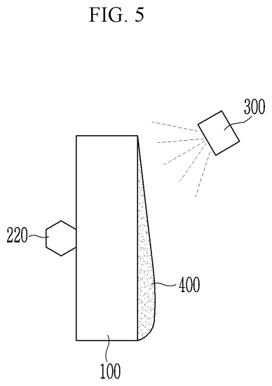

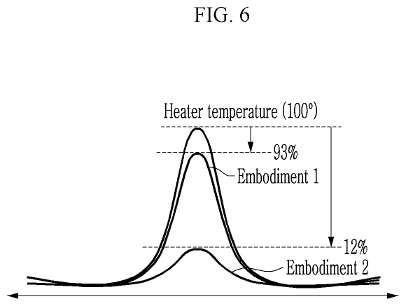

FIG. 5 illustrates a configuration in which a glass 100 is disposed vertically according to another embodiment. As shown in FIG. 5, in case that the glass 100 is perpendicularly disposed, the etchant 400 sprayed from the applier 300 is applied so that it becomes thicker as it goes downward by the gravity. Therefore, a portion where the heater 220 is disposed corresponds to the portion where the etchant 400 is applied the thickest in an embodiment described with reference to FIG. 4, and they do not correspond to each other in an embodiment described with reference to FIG. 5. Therefore, heat efficiency is reduced in an embodiment described with reference to FIG. 5, compared to an embodiment described with reference to FIG. 4.

FIG. 6 illustrates heat efficiency for respective regions according to an embodiment (Embodiment 1) described with reference to FIG. 4 and an embodiment (Embodiment 2) described with reference to FIG. 5. As shown in FIG. 6, it is found that the heat efficiency is significantly high in an embodiment described with reference to FIG. 4 in which the glass 100 is disposed horizontally flat.

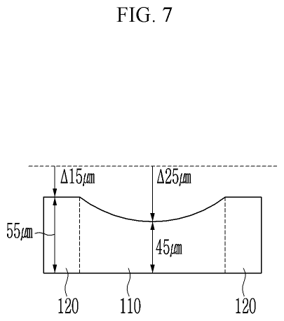

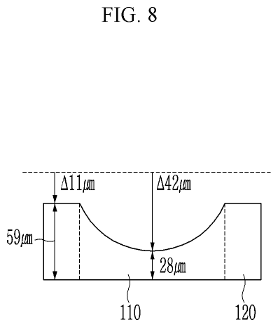

FIG. 7 illustrates a shape of an etched glass in a cross-sectional view according to an embodiment described with reference to FIG. 5 in a same condition, and FIG. 8 illustrates a shape of an etched glass in a cross-sectional view according to an embodiment described with reference to FIG. 4 in a same condition. Comparing FIGS. 7 and 8, FIG. 7 illustrates that a thickness difference between a folding region 110 of the glass and an unfolding region 120 is about 10 μm, the folding region 110 is etched by about 25 μm, and the unfolding region 120 is etched by about 15 μm.

However, in the case of FIG. 8 in which the glass 100 is horizontally disposed, FIG. 8 illustrates that a thickness difference between the folding region 110 of the glass and the unfolding region 120 is given as about 31 μm, the folding region 110 is etched by about 42 μm, and the unfolding region 120 is etched by about 11 μm. For example, an etching ratio of the folding region 110 to the unfolding region 120 is shown to be greater, compared to the case of FIG. 7.

To effectively fold the glass 100 and acquire impact resistance for external impacts, it is desirable for the folding region 110 to be thin and for the unfolding region 120 to be thick. For example, the embodiment described with reference to FIG. 4 in which the glass 100 is horizontally disposed may be further well folded and may have excellent impact resistance compared to the embodiment with reference to FIG. 5 in which the glass 100 is perpendicularly disposed.

In the case of the etching device according to the embodiment, no additional mask is used, and the etchant 400 is applied on the front of the glass 100. A groove of the freely curved surface is formed by promotion of etching caused by the thickness difference according to the surface tension of the etchant 400 and the heater 220 disposed below the glass 100. According to the above-noted etching method, the internal stress may be maintained, compared to the method for etching a groove by artificial use of a mask.

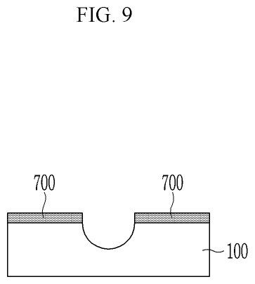

FIG. 9 illustrates a glass 100 etched by positioning a mask 700 in a cross-sectional view. As shown in FIG. 9, the glass 100 is masked by the mask 700, and a region in which the mask 700 is not disposed is etched.

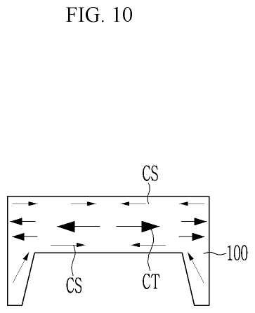

FIG. 10 illustrates an inner stress of a glass 100 according to an embodiment described with reference to FIG. 9. Referring to FIG. 10, FIG. 9 illustrates that the region covered by the mask 700 is not etched and the exposed region is etched, so the stress in the glass 100 is non-uniform. Referring to FIG. 10, it is found that the compressive stresses (CS) are different for respective regions, and the central tensions (CT) are also irregular.

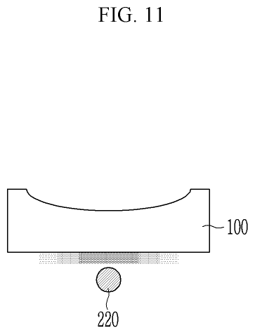

FIG. 11 illustrates an etched glass 100 according to an embodiment. Referring to FIG. 11, the front side of the glass 100 is etched, and the region in which the heater 220 is disposed is much more etched. Therefore, the glass 100 is etched to have a curved surface according to a distribution of heat from the heater 220, and as shown in FIG. 11, the etched side has a freely curved surface.

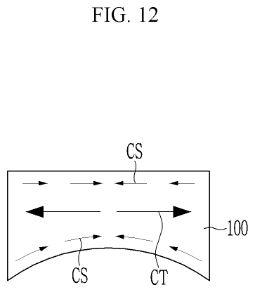

FIG. 12 illustrates an inner stress of a glass 100 according to an embodiment described with reference to FIG. 11. As shown in FIG. 12, the compressive stress (CS) and the central tension (CT) are uniformly and symmetrically formed in the glass 100 of FIG. 11.

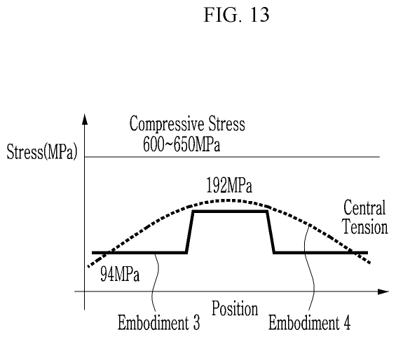

FIG. 13 illustrates an inner stress with respect to positions according to an embodiment (Embodiment 3) described with reference to FIGS. 9 and 10 and an embodiment (Embodiment 4) described with reference to FIGS. 11 and 12. Referring to FIG. 13, the central tensions are differently formed for the respective regions in Embodiment 3 in which the glass is etched by using the mask 700, and it is found that the central tension is distributed in a curved line in Embodiment 4 in which the glass is etched according to the embodiment.

Regarding the etching device according to the embodiment, the heater 220 may directly contact the glass 100, or it may be disposed in the supporter 200 and may not directly contact the glass 100.

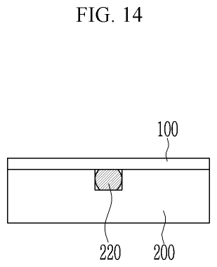

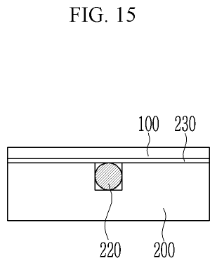

FIGS. 14 and 15 illustrate shapes of a heater 220 according to various embodiments.

Referring to FIG. 14, the heater 220 may be formed in the groove of the supporter 200, or it may directly contact the glass 100. In case that the heater 220 directly contacts the glass 100, heat transmission and heat efficiency are excellent. In this case, it is needed to seal the surface of the heater 220 with a chemical resistance material. This is because the heater 220 may be damaged in a process for cleaning the glass 100.

Referring to FIG. 15, the heater 220 may be buried or embedded in the supporter 200, or may not directly contact the glass 100. For example, as shown in FIG. 15, a chemically resistant layer 230 may be coated on the heater 220. In this case, the glass 100 does not directly contact the heater 220 so that the etching quality of the surface of the glass 100 may be excellent.

The supporter 200 may include a material with an acid-resistant characteristic such as Teflon® or PVC. The heater 220 may be a sheath heater (coil or wire heater), an infrared (IR) heater, or a lamp.

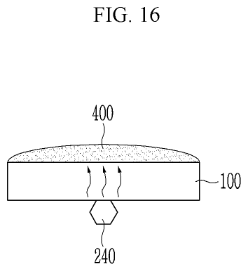

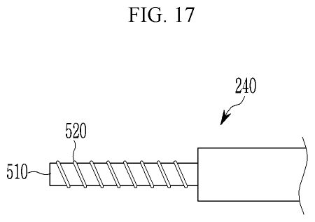

FIGS. 16 and 17 illustrate a sheath heater 240. Referring to FIG. 17, the sheath heater 240 includes a core 510 and a wire 520 wound around the core 510. The sheath heater 240 may directly transmit heat to the glass 100 by a conduction or convection method as shown in FIG. 16.

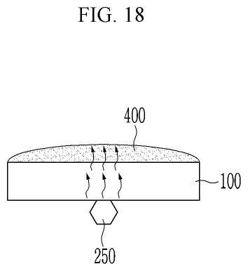

FIG. 18 illustrates an infrared heater 250. The infrared heater 250 transmits heat by a conduction, convection, or radiation method. The infrared heater 250 may, as shown in FIG. 18, directly transmit heat to the etchant 400 through the glass 100. This is because the glass 100 transmits the infrared rays. Referring to FIG. 18, mid/far-infrared rays may be absorbed into the glass 100, and near-infrared rays may transmit through the glass 100 and may be transmitted to the etchant 400.

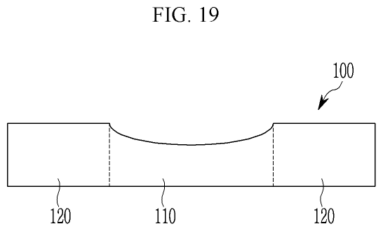

The groove of the glass 100 etched by the etching device according to the disclosure has a freely curved surface, so that it is appropriate to be applied to the foldable display device. FIG. 19 illustrates an etched glass 100 according to an embodiment. Referring to FIG. 19, the glass 100 is divided into a folding region 110 and an unfolding region 120. The thickness of the folding region 110 may be about 25 μm to about 30 μm. The thickness of the unfolding region 120 may be about 50 μm to about 70 μm. The thickness difference between the folding region 110 and the unfolding region 120 may be about 1.5 times to about 2.5 times. For example, the unfolding region 120 may be about times 1.5 to about 2.5 times thicker than the folding region 110. In the specification, the thickness of the folding region 110 represents the thickness of the thinnest portion.

By the thickness difference between the folding region 110 and the unfolding region 120, the glass 100 may be well bent in the folding region 110 and may have impact resistance against the external impacts. For example, in case that the thickness of the folding region 110 is greater than about 30 μm, the glass 100 may not be well bent, and in case that the thickness of the unfolding region 120 is less than about 50 μm, the glass 100 may be easily damaged by the external impacts.

An etching method according to the embodiment will now be described. The etching method may be performed by using the above-described etching device. The etching may be performed for a first time or a second time.

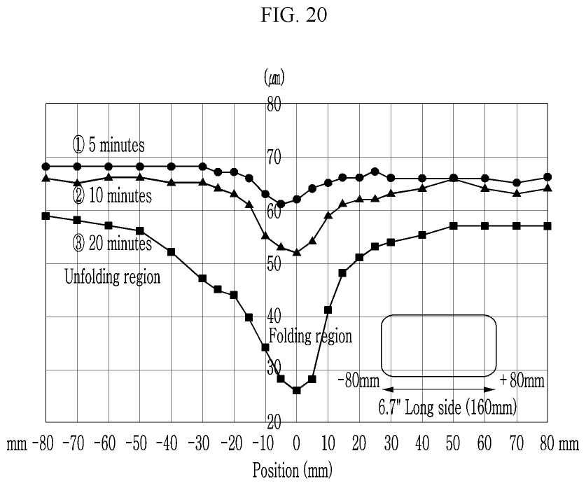

FIG. 20 illustrates thicknesses for respective glass regions with respect to etching time in an etching method according to an embodiment. Referring to FIG. 20, the center portion corresponds to the folding region. It is found that, as an etching time passes by, the glass becomes thinner, and particularly, as the etching passes, the folding region becomes thinner, and the thickness difference between the folding region and the unfolding region is increased.

In case that the thickness difference between the folding region and the unfolding region is increased as described above, it is appropriate to be applied to the foldable display device, and the sludge generated for the etching process may gather in the folding region.

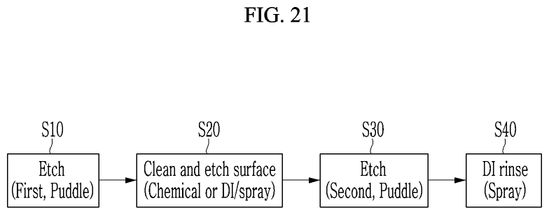

The etching method according to an embodiment may perform etching at least twice to remove the sludge. FIG. 21 illustrates a process of an etching method according to an embodiment.

Referring to FIG. 21, the etching method includes: performing etching for a first time (S10), cleaning a surface (S20), performing etching for a second time (S30), and performing cleaning and drying (S40).

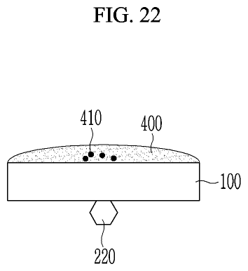

Respective stages will now be described in detail with reference to FIGS. 21 and 22 to 25. FIG. 22 illustrates a stage (S10) for etching for a first time. Referring to FIG. 22, an etchant 400 is applied on the glass 100. The glass 100 is horizontally disposed, and the upper side of the etchant 400 is disposed to be curved by the surface tension. A sludge 410 may be generated in the etching process. The etching of the glass 100 may be performed as the following reactive formula, and the amount of sludge may be increased as the etching proceeds.

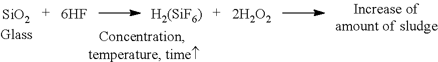

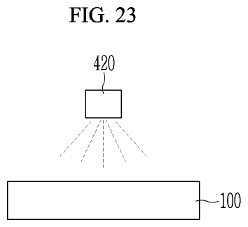

FIG. 23 illustrates a stage (S20) for cleaning a surface. Referring to FIG. 23, the sludge on the surface is removed by cleaning the etched glass 100. In this instance, distilled water or an etchant may be used as a cleaning solution 420. In case that the etchant is used, this may be the same etchant as the etchant used in the stage (S10) for performing etching for a first time, or it may be another etchant. In case that the etchant and not the distilled water is used in the cleaning, the cross-section of the glass 100 may be etched in a small amount during the cleaning.

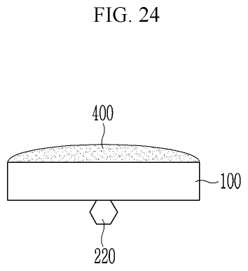

FIG. 24 illustrates a stage (S30) for etching for a second time. Referring to FIG. 24, an etchant 400 is applied on the glass 100. The glass 100 is horizontally disposed, and the upper side of the etchant 400 is disposed to have a curved surface by the surface tension.

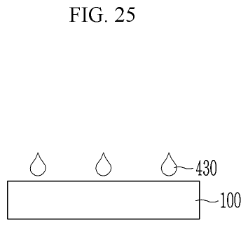

FIG. 25 illustrates a stage (S40) for performing cleaning and drying. Referring to FIG. 25, the surface of the etched glass 100 is cleaned and dried by using the distilled water 430.

Regarding the etching method according to the embodiment, the etchant 400 may be applied with a thickness of about 2 mm to about 4 mm. In case that the applied thickness of the etchant 400 is less than or equal to about 2 mm, the etching may be insufficiently performed. In case that the thickness is greater than or equal to about 4 mm, a temperature gradient may not be formed on the upper side of the etchant 400 so that the upper side of the etchant 400 may not be well etched. In the specification, the thickness of the etchant indicates the thickness at the thickest portion.

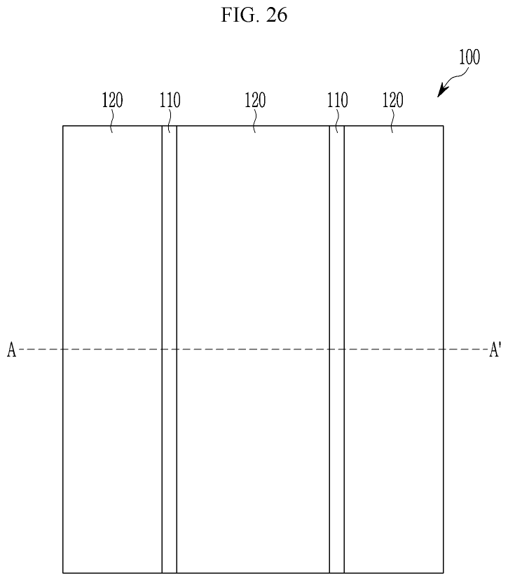

FIG. 26 illustrates a glass 100 including a folding region 110 and an unfolding region 120. Regarding the glass 100 shown in FIG. 26, the thickness of the etchant 400 is varied, the temperature of the heater is increased, and the temperature gradient for respective regions is measured.

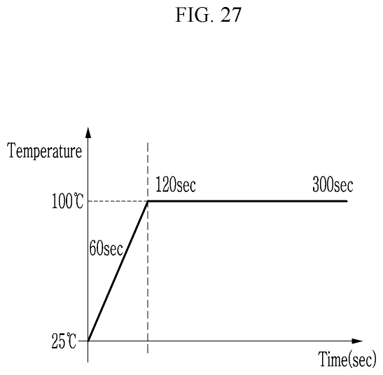

FIG. 27 illustrates a temperature with respect to time in an experiment. The temperature is increased as shown in FIG. 27 for the glass 100 of FIG. 26.

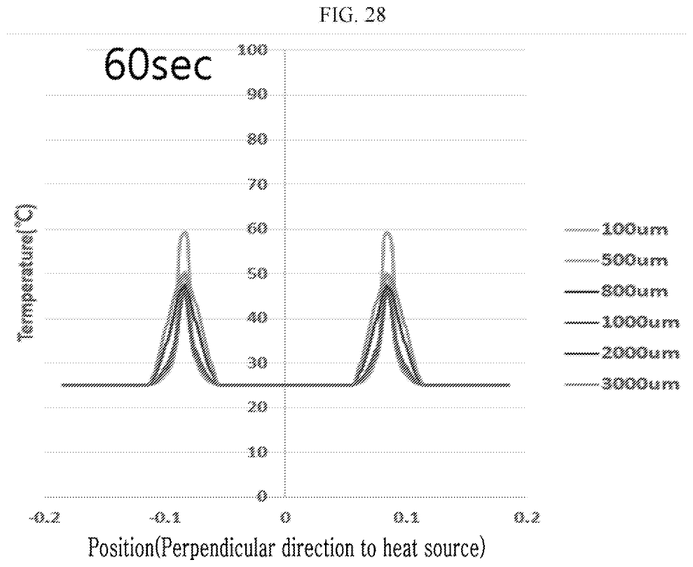

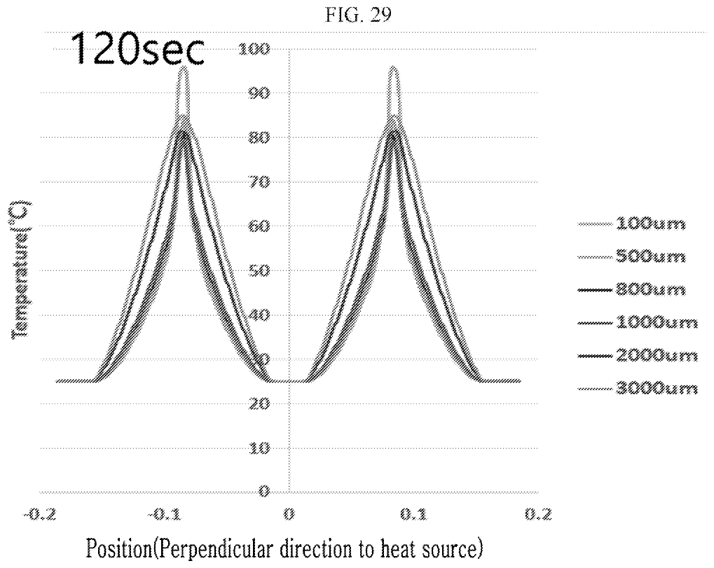

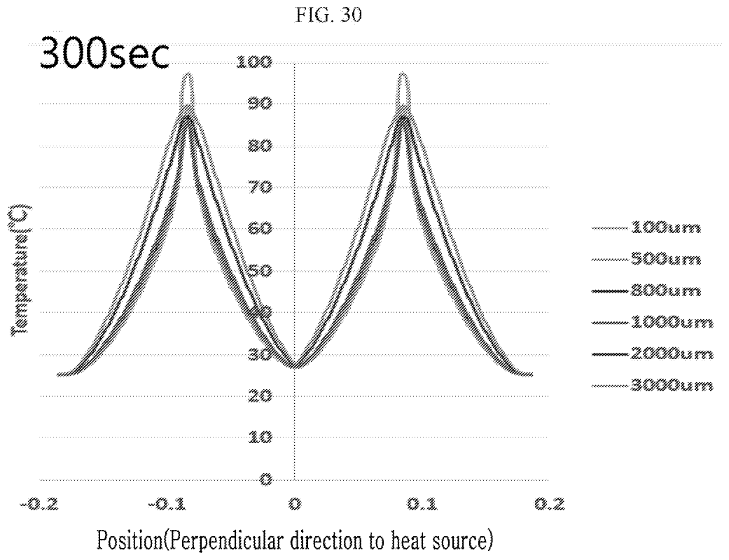

FIGS. 28 and 30 illustrate measured temperature gradients for respective regions with respect to line A-A′ of FIG. 26 after applying an etchant 400 with a thickness of about 3.5 mm. FIGS. 28 to 30 illustrate measurement of respective temperature gradients on the points of about 100 μm, about 500 μm, about 800 μm, about 1000 μm, about 2000 μm, and about 3000 μm from the surface of the glass 100. Referring to FIG. 28 to FIG. 30, it is found that the temperature gradients are formed at the points of the etchant of about 100 μm, about 500 μm, about 800 μm, about 1000 μm, about 2000 μm, and about 3000 μm until the temperature rising time increases to about 60 seconds from about 300 seconds.

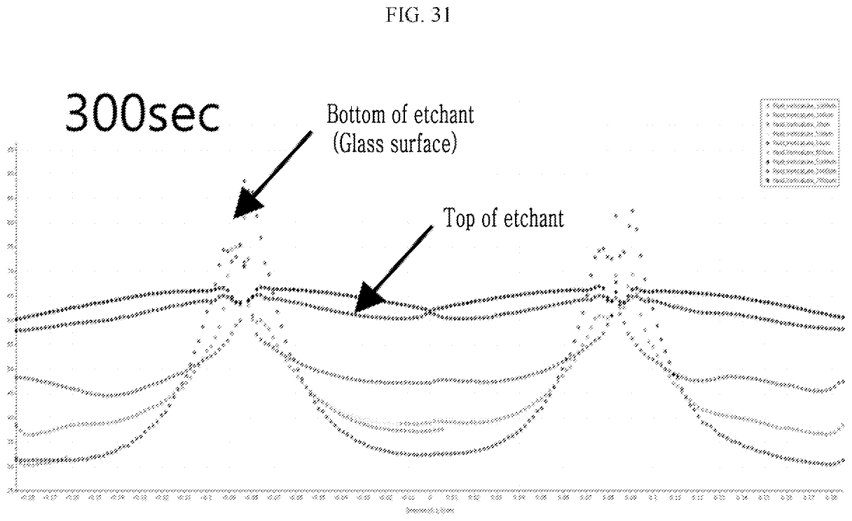

FIG. 31 illustrates measured temperature gradients for respective regions with respect to line A-A′ of FIG. 26 after applying an etchant 400 with a thickness of about 10 mm. Referring to FIG. 31, it is found that after about 300 seconds pass, the temperature gradient is formed at the bottom of the etchant 400, for example, on the surface of the glass 100, and the temperature gradient is not formed at the top of the etchant becoming distant from the glass 100. Therefore, it is found that it is undesirable in case that the etchant 400 is applied to be thick.

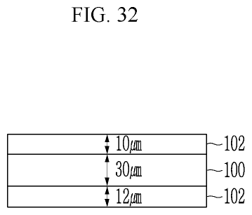

The glass 100 manufactured according to the embodiment has excellent impact resistance. FIG. 32 illustrates a glass that is not etched according to an embodiment, and a coating layer 102 is disposed on respective sides of the glass 100.

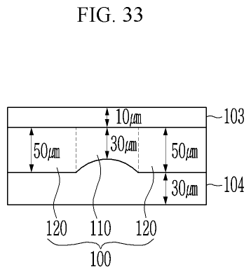

FIG. 33 illustrates an etched glass 100 according to an embodiment, and a coating layer 103 is disposed on a side of the glass 100, and the glass 100 includes a folding region 110 and an unfolding region 120 that have different thicknesses by the etching. A filling coating layer 104 is disposed on another side of the glass 100. The filling coating layer 104 may fill the folding region 110.

A pen drop test was performed on the glass according to embodiments described with reference to FIGS. 30 and 31, and results are shown in Table 1.

TABLE 1

| | Corresponding drawings | |
|---|---|---|
| | FIG. 30 | FIG. 31 |
| Layer stacking | coating layer 10 μm | coating layer 10 μm |
| structure | glass 30 μm | glass 50 μm/30 μm/50 μm |
| | coating layer 10 μm | (folding region 30 μm, and |
| | | unfolding region 50 μm) |
| | | Filling coating layer 30 μm |
| Bright spot | 9 cm | 14 cm |
| Breakage | 13 cm | 14 cm |

As shown in Table 1, it is found that a height of generating a bright spot and a height of generating breakage of the glass 100 of FIG. 33 etched according to the embodiment are increased. For example, it is found that impact resistance of the glass etched according to the embodiment is desirable.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. An etching device comprising:
a chamber;
a supporter disposed in the chamber;
a heater disposed in the supporter; and
an applier disposed on the supporter, wherein
a glass is disposed on the supporter, and
the applier applies an etchant on the glass such that a thickness of the etchant applied reduces from a center of the glass toward an edge of the glass.

2. The etching device of claim 1, wherein the heater overlaps a thickest portion of the etchant applied on the glass.

3. The etching device of claim 1, wherein the heater directly contacts the glass.

4. The etching device of claim 1, further comprising:
a chemically resistant layer disposed between the heater and the glass,
wherein the heater does not directly contact the glass.

5. The etching device of claim 1, wherein the heater is a sheath heater, an infrared heater, or a lamp.

6. The etching device of claim 1, wherein the applier has a syringe or slit form.

7. The etching device of claim 1, wherein the applier sprays an etchant or a cleaning solution according to a process.

8. The etching device of claim 1, wherein
a groove is formed on a portion of the glass etched by the etching device where the heater is disposed, and
a surface of the groove has a freely curved surface.

9. An etching method comprising:
positioning a glass on a supporter including a heater;
applying an etchant on the glass such that a thickness of the etchant applied reduces from a center of the glass toward an edge of the glass; and
etching the glass with the etchant to form an etched glass,
wherein the heater overlaps a thickest portion of the etchant applied on the glass.

10. The etching method of claim 9, wherein
a region of the etched glass overlapping the heater is etched more than a region of the etched glass not overlapping the heater, and
the etched glass is etched less as the etched glass becomes distant from the heater.

11. The etching method of claim 10, wherein
a groove is formed in a portion of the etched glass overlapping the heater, and
a surface of the groove has a freely curved surface.

12. The etching method of claim 11, wherein
a thickness of a thinnest portion of a region of the etched glass having the groove is in a range of about 25 μm to about 30 μm, and
a thickness of a region of the etched glass not having the groove is in a range of about 50 μm to about 70 μm.

13. The etching method of claim 11, wherein a thickness of the region of the etched glass not having the groove is in a range of about 1.5 to about 2.5 times the thickness of the region of the etched glass having the groove.

14. The etching method of claim 9, further comprising:
after the etching of the glass with the etchant to form the etched glass, applying a cleaning solution on the etched glass, and cleaning the etched glass to remove an etching sludge.

15. The etching method of claim 14, further comprising:
after the cleaning of the etched glass to remove the etching sludge, applying another etchant on the cleaned etched glass to etch the cleaned etched glass for a second time.

16. The etching method of claim 15, wherein the cleaning of the etched glass and the applying of the another etchant are performed in a same chamber.

17. The etching method of claim 16, wherein the cleaning solution is distilled water or a cleaning etchant.

18. The etching method of claim 9, wherein a thickness of the etchant applied to the glass is in a range of about 2 mm to about 4 mm.

19. The etching method of claim 9, wherein a mask is not used for the etching of the glass.

20. The etching method of claim 9, wherein
the heater directly contacts the glass, or
the heater includes a chemically resistant layer disposed between the heater and the glass, and does not directly contact the glass.
